(19) United States
(12) Patent Application Publication
(10) Pub. No.: US 2004/0171732 A1
(43) Pub. Date: Sep. 2, 2004

(54) Water based resin composition method for producing the same and its applications

(76) Inventors: Hideo Matsuzaki, Tokai-shi (JP); Hiroaki Ishii, Yokohama-shi (JP); Kotaro Yoneda, Nagoya-shi (JP); Michihiro Kaai, Toyoake-shi (JP); Akemi Koketsu, Nisshin-shi (JP)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/481,141

(22) PCT Filed: Apr. 26, 2002
(86) PCT No.: PCT/JP02/04209

(30) Foreign Application Priority Data
Jun. 25, 2001 (JP) 2001-190800

(51) Int. Cl. C08K 3/20

(52) U.S. Cl. 524/457

(57) ABSTRACT

A water-based resin dispersion, a method for producing the water-based resin dispersion, and its applications. The water-based resin dispersion of the invention is excellent in permeability, leveling property and chemical stability. The water-based resin dispersion is produced by causing reaction of macromonomer composition and a vinyl monomer in an aqueous medium. The macromonomer composition is obtained by polymerization of a monomer mixture in a temperature range between 160° C. and 350° C., wherein a monomer mixture contains, with respect to the total amount of all monomers provided for the production of the macromonomer composition, for example: a vinyl monomer having alkyl group in the α-position at 10 to 80 weight %; a non-aromatic vinyl monomer having hydrogen atom in the α-position at 90 weight % or less; and styrene at 30 weight % or less. The macromonomer composition includes a hydrophilic monomer unit and a hydrophobic monomer unit.

### TECHNICAL FIELD

The present invention relates to water-based resin dispersion which is obtained by reacting a vinyl monomer and a macromonomer composition that contains a specific macromonomer, to a method for producing the same, and to its applications. In particular, the invention relates to water-based resin dispersion obtained through copolymerization of macromonomer and vinyl monomer in aqueous medium, and method for producing and the applications thereof.

### BACKGROUND ART

A method for producing water-based resin dispersion through copolymerization of macromonomer composition and vinyl monomer in aqueous medium is known (PCT International Publication WO01/04163, Japanese Laid-Open Patent Publication 8-3256 and Japanese Laid-Open Patent Publication 2000-80288). The macromonomer composition is obtained by polymerizing the monomers at high temperatures in a range between 150° C. and 350° C.

However, in the above described method for producing the water-based resin dispersion, there was a disadvantage in that the permeability and the leveling performance of the water-based resin dispersion thus obtained were inferior due to the macromonomer composition used in the method. Further, when inorganic salt was mixed into the above dispersion, the dispersion could fall in a state in which the dispersion was separated from the medium, for example by precipitation. Accordingly, the dispersion had inadequate stability in the applications where inorganic salt could mix into the dispersion, and that limited the use of the dispersion.

The present invention is made in view of the disadvantage described in relation to the conventional art. An object of the invention is to provide water-based resin dispersion which has good permeability, leveling property and chemical stability, to provide a method for producing the water-based resin dispersion to readily obtain the same, and to provide the applications of the water-based resin dispersion.

### DISCLOSURE OF THE INVENTION

In order to solve the above described object, a method for producing water-based resin dispersion according to an embodiment of the invention is characterized by reaction of a specific macromonomer composition and vinyl monomer in aqueous medium. The macromonomer composition has hydrophilic monomer unit and hydrophobic monomer unit. The macromonomer composition is obtained by polymerization of a monomer mixture in a temperature range between 160° C. and 350° C. With respect to the total amount of all monomers provided for the production of the macromonomer composition, the monomer mixture contains: a vinyl monomer having alkyl group in the α-position at 10 to 80 weight %; and a non-aromatic vinyl monomer having hydrogen atom in the α-position at 90 to 20 weight %.

In another embodiment, a method for producing water-based resin dispersion of the invention is characterized by reaction of a specific macromonomer composition and a vinyl monomer in aqueous medium. The macromonomer composition has hydrophilic monomer unit and hydrophobic monomer unit. The macromonomer composition is obtained by polymerization of a monomer mixture in a temperature range between 160° C. and 350° C. With respect to the total amount of all monomers provided for the production of the macromonomer composition, the monomer mixture contains: a vinyl monomer having alkyl group in the α-position at 70 weight % or more and styrene at 30 weight % or less.

In further embodiment a method for producing water-based resin dispersion of the invention is characterized by reaction of a specific macromonomer composition and a vinyl monomer in aqueous medium. The macromonomer composition has hydrophilic monomer unit and hydrophobic monomer unit. The macromonomer composition is obtained by polymerization of a monomer mixture in a temperature range between 160° C. and 350° C. With respect to the total amount of all monomers provided for the production of the macromonomer composition, the monomer mixture contains: a vinyl monomer having alkyl group in the α-position at 10 to 80 weight %; a non-aromatic vinyl monomer having hydrogen atom in the α-position at 90 weight % or less; and styrene at 30 weight % or less.

In the production method of the water-based resin dispersion according to the present invention, preferably more than 60 weight % of the hydrophilic monomer unit contained in the macromonomer composition is originated from the vinyl monomer having alkyl group in the α-position.

In the production method of the water-based resin dispersion according to the present invention, preferably the hydrophilic group which constitutes the hydrophilic monomer unit contained in the macromonomer composition is carboxyl group. More preferably, a portion or all of the carboxyl group contained in the macromonomer composition is neutralized by alkali.

In an embodiment of the production method for water-based resin dispersion according to the present invention, the macromonomer composition is obtained through polymerization when the total amount of a monomer and polymer generated by polymerization of the monomer is in a concentration range between 50 and 100 weight % with respect to the amount of polymerization reaction solution in the production of the macromonomer composition.

In the production method of water-based resin dispersion of the present invention, the vinyl monomer having an alkyl group in the α-position is preferably methacrylic acid or methacrylate ester.

Further in the production method of water-based resin dispersion of the invention, the proportion of the macromonomer composition, which is reacted with the vinyl monomer in aqueous medium, is in a range between 20 and 300 wt. % with respect to vinyl monomer.

In the production method of water-based resin dispersion of the invention, the proportion of the macromonomer composition, which is reacted with the vinyl monomer in aqueous medium, is in a range between 1 and 20 wt. % with respect to vinyl monomer.

In the production method of water-based resin dispersion of the invention, the macromonomer composition is preferably obtained in polymerization time between 0.1 and 1 hour.

The water-based resin dispersion of the invention is preferably obtained through the method for producing water-based resin dispersion according to the present invention.

The water-based sealer composition of the present invention may be preferably produced in a method in which the proportion of the macromonomer composition reacted with the vinyl monomer in aqueous medium is in a range between 20 and 300 weight % with respect to the vinyl monomer.

The water-based paint composition of the invention is preferably produced in a method in which the proportion of the macromonomer composition reacted with the vinyl monomer in aqueous medium is in a range between 1 and 20 weight % with respect to the vinyl monomer.

### BEST MODE FOR CARRYING OUT THE INVENTION

Embodiments of the present invention are described in detail below.

In a method for producing water-based resin dispersion of the invention, a specific macromonomer composition and vinyl monomer are reacted in aqueous medium. In other words, in the method for producing water-based resin dispersion of the invention, a macromonomer contained in the specific macromonomer composition and the vinyl monomer are copolymerized in the aqueous medium.

The macromonomer composition is first described.

The term “specific macromonomer” denotes a composition which is obtained by polymerization of monomer mixture in a temperature range between 160 and 350° C. and which has hydrophilic monomer unit and hydrophobic monomer unit. There are three kinds for the monomer mixture as follows. The first monomer mixture contains with respect to the total amount of all monomers provided for production of the macromonomer composition, a vinyl monomer having alkyl group in the α-position at 10 to 80 weight %, and a non-aromatic vinyl monomer having hydrogen atom in the α-position at 90 to 20 weight %. The second monomer mixture contains with respect to the total amount of all monomers provided for production of the macromonomer composition, a vinyl monomer having alkyl group in the α-position at 70 weight % or more and styrene at 30 weight % or less. The third monomer mixture contains with respect to the total amount of all monomers provided for production of the macromonomer composition, a vinyl monomer having alkyl group in the α-position at 10 to 80 weight %, a non-aromatic vinyl monomer having hydrogen atom in the α-position at 90 weight % or less, and styrene at 30 weight % or less.

Optionally, another vinyl monomer having an alkyl group in the α-position, non-aromatic vinyl monomer having hydrogen atom in the α-position, or other monomer except styrene can be contained for the monomer which is provided for producing macromonomer composition.

The vinyl monomer having alkyl group in the α-position is an essential component to increase macromonomer content in producing the macromonomer composition. The vinyl monomer having alkyl group in the α-position is further an essential component to lower the molecular weight distribution of the copolymer of the macromonomer and the vinyl monomer. Examples of the vinyl monomer having alkyl group in the α-position are: α-alkyl acrylate; α-alkyl acrylamide; α-alkyl acrylate ester; α-alkyl styrene; and α-alkyl acyrilonitrile, etc.

Examples of the alkyl group are alkyl groups having carbon numbers of 4 or less, more specifically, methyl group, ethyl group, propyl group and butyl group. Among these, the monomer having methyl group as the alkyl group is preferable in that the monomer is readily available and in that the monomer content can be increased. The examples of such vinyl monomers are: methacrylic acid; methacrylate ester; α-methyl styrene; methacrylonitrile and methacrylamide.

Among the vinyl monomers having alkyl group in the α-position, methacrylic acid and methacrylate ester are specifically preferable because the macromonomer content of the obtained macromonomer composition can be increased. The examples of methacrylate ester are: methyl methacrylate; ethyl methacrylate; propyl methacrylate; butyl methacrylate; isobutyl methacrylate; 2-ethylhexyl methacrylate; stearyl methacrylate; lauryl methacrylate; decyl methacrylate; cyclohexyl methacrylate; isobornyl methacrylate; benzyl methacrylate; 2-hydroxyethyl methacrylate; 2-hydroxypropyl methacrylate; 2-hydroxybutyl methacrylate; monoglycerol methacrylate ester; cyclohexane dimethanol monomethacrylate ester; alkoxyethyl methacrylate; alkoxypropyl methacrylate; glycidyl methacrylate; and alkylaminoalkyl methacrylate ester; dialkylaminoalkyl methacrylate ester; and polyfunctional monomers such as polyalkyleneglycol dimethacrylate ester and alkyldiol dimethacrylate ester.

Examples of the non-aromatic vinyl monomer having hydrogen atom in the α-position are: acrylic acid; acrylate ester; acrylamide; maleic anhydride; acrylonitrile; poly(vinyl acetate); and poly(vinyl chloride). The examples of the acrylate ester are: methyl acrylate; ethyl acrylate; propyl acrylate; butyl acrylate; isobutyl acrylate; 2-ethylhexyl acrylate; lauryl acrylate; isobornyl acrylate; stearyl acrylate; decyl acrylate; cyclohexyl acrylate; 2-hydroxyethyl acrylate; hydroxypropyl acrylate; hydroxybutyl acrylate; cyclohexane dimethanol monoacrylate ester; alkoxyethyl acrylate; alkoxypropyl acrylate; polyalkyleneglycol monoacrylate ester; alkylaminoalkyl acrylate ester; dialkylaminoalkyl acrylate ester; and polyfunctional monomers such as polyalkylene glycol diacrylate ester and alkyldiol diacrylate ester.

In order to adjust properties of the macromonomer composition and the copolymer obtained from the macromonomer composition, other vinyl monomer can be mixed. The examples of the other vinyl monomer are styrene sulfonate, vinylidene monomer, α-hydroxy acrylate ester monomer and itaconic acid, etc.

The macromonomer composition contains hydrophilic monomer unit as described above. The hydrophilic monomer unit denotes a structural unit of the macromonomer formed through copolymerization of monomers having hydrophilic group. In this case, the hydrophilic monomer is a monomer which has a solubility exceeding 2 weight % to water at 20° C. The hydrophilic monomer unit has hydrophilic property because the monomer composition used for macromonomer production contains hydrophilic monomer. In the case where the monomer composition did not contain any hydrophilic monomer, the hydrophilic monomer unit was provided with hydrophilic property because hydrophilic group was introduced during polymerization or after the polymerization.

The examples of hydrophilic groups are: carboxyl group; sulfonate group; phosphate group; sulfinic group; phosphite group; and amino group, or the salts of these. The examples also include amide group, imide group, hydroxyl group, nitryl group and polyoxyethylene group, etc.

Among these, acid groups and the salts, such as carboxyl group are preferable because they improve water-resistant property of the film formed from the water-based resin dispersion obtained from the macromonomer composition. The examples of monomer having acid group are: (meth)acrylic acid, maleic acid (and its anhydride), itaconic acid (and its anhydride), styrene sulfonate, and 2-(meth)acrylamide-2-methylpropane sulfonate, etc. A portion of all of these acid groups are preferably neutralized. The macromonomers having neutralized acid groups will have ionic group in aqueous medium to improve stability during production of water-based resin dispersion and after the production.

The macromonomer composition also includes hydrophobic monomer unit. The hydrophobic monomer unit has hydrophobic property because the monomer composition used for production of macromonomer contains hydrophobic monomer. Here, the hydrophobic monomer denotes a monomer which has solubility of 2 weight % or less to water at 20° C.

Because the macromonomer composition of the invention has hydrophilic monomer unit and hydrophobic monomer unit, while it can dissolve or self-disperse in the aqueous medium, it can also form a hydrophobic field through intramolecular and intermolecular association. The hydrophobic monomer is solubilized or emulsified in this hydrophobic field to form polymerization field and further the polymer particles formed by the polymerization are stably dispersed in the aqueous medium. In other words, the macromonomer composition can function as emulsifier by containing hydrophilic monomer unit and hydrophobic monomer unit. Because the monomer composition functions as polymer emulsifier, polymerization can be stably performed in aqueous medium without using conventional emulsifier (hereinafter simply referred to as “emulsifier”) such as sodium dodecyl sulfate, sodium alkylbenzene sulfonate, polyoxyethylene alkylphenyl ether, etc.

While emulsifiers can reduce water-resisting property and strength of the coatings, the present invention is advantageous because emulsifier is not necessary. The macromonomer composition of the present invention not only stabilizes polymerization by means of adsorption to the produced polymer particle, but also stabilizes by existing in a state bonded to the polymer particle surface by covalent bond by copolymerization with the vinyl monomer. Accordingly, water-based resin dispersion having improved stability can be obtained. Further, the macromonomer composition of the present invention can provide water-based resin dispersion having good permeability and leveling property since the macromonomer composition is capable of forming a copolymer with the vinyl monomer that has a narrow molecular weight distribution.

The content of each monomer within the macromonomer composition is such that the vinyl monomer having alkyl group in the α-position is contained at 10 to 80 weight % in the cases of the first monomer mixture and the third monomer mixture. The amount contained is preferably in a range between 15 and 75 wt. %, more preferably in a range between 20 and 70 wt. %, further preferably in a range between 35 and 70 wt. %, and most preferably in a range between 40 and 70 wt. %. The vinyl monomer having alkyl group in the α-position is contained at 70 wt. % or more in the case of the second monomer mixture. If the content of the vinyl monomer having alkyl group in the α-position is too small, the molecular weight distribution is large in the copolymer formed from the macromonomer and the vinyl monomer. Accordingly, the permeability and leveling property can be inferior when water-based resin dispersion is formed from such copolymer for an application of a coating film. The polymer then formed can have an extremely large molecular weight distribution (weight average molecular weight/number average molecular weight). When the amount of the vinyl monomer having alkyl group in the α-position used is too much, the reaction rate of the monomers in macromonomer composition production can be low to result in inferior production efficiency of the macromonomer.

The content of the non-aromatic vinyl monomer having hydrogen atom in the α-position is in a range between 90 and 20 wt. % in the case of the first monomer mixture and at 90 wt. % or less in the case of the third monomer mixture.

The content of styrene is 30 wt. % or less both in the second monomer mixture and the third monomer mixture. The styrene content is preferably 20 wt. % or less, more preferably 15 wt. % or less, further preferably 10 wt. % or less, and most preferably 5 wt. % or less. The reaction rates of the macromonomer and the vinyl monomer can decrease in the copolymerization reaction between the macromonomer and the vinyl monomer when the content of styrene is too high. As methods for increasing reaction rate of the copolymerization reaction which uses macromonomer in which styrene content exceeds 30 wt. %, there are for example a method of increasing the amount of polymerization initiator used, a method of increasing polymerization time and a method of increasing polymerization temperature. In these cases, the productivity of the copolymers was inferior or the obtained copolymer can be colored or can have bad weathering resistance because the copolymer contains more residue of the polymerization initiator. Accordingly, in order to react the macromonomer composition and the vinyl monomer under a relatively mild condition to copolymerize the macromonomer and the vinyl monomer at a high reaction rate, the macromonomer preferably include the styrene unit at a content as low as possible.

The content of the other vinyl monomer is in a range between 0 and 90 wt. % in the first, the second and the third monomer mixtures.

The macromonomer composition is obtained by polymerizing the monomer mixture at a temperature in a range between 160 and 350° C. The reaction temperature in the macromonomer composition production is more preferably in a range between 180 and 320° C., further preferably in a range between 200 and 300° C., and most preferably in a range between 220 and 300° C.

When the monomer mixture is polymerized at high temperature as described above, the polymerization reaction proceeds in accordance with reaction mechanism shown below. Hydrogen atom in the α-position of the generated polymer chain is extracted by active radical, then a cleavage reaction occurs at carbon-carbon bond in the β-position, and a macromonomer having terminal double bond is formed.

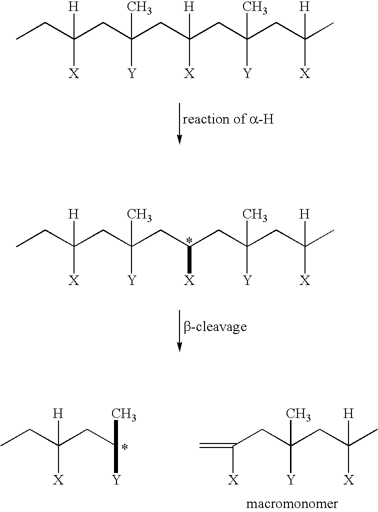

According to this reaction mechanism, when the proportion of the hydrophilic monomer unit is originated from a monomer having hydrogen in the α-position increases, namely the proportion that X in the reaction mechanism is hydrophilic group increases, the proportion of hydrophilic group bonded to the terminal double bond of the macromonomer increases. On the other hand, the proportion of the hydrophilic monomer unit originated from a monomer having alkyl group in the α-position, namely the proportion that X in the reaction mechanism is hydrophobic group increases, the proportion of hydrophobic group bonded to the terminal double bond of the macromonomer increases. In other words, it is possible in the macromonomer of the invention to control the hydrophilic and hydrophobic property of the terminal double bond portion of the macromonomer, depending on whether the hydrophilic monomer unit is originated from a monomer having hydrogen atom in the α-position or it is originated from a monomer having alkyl group in the α-position.

In the case where the macromonomer and the hydrophobic monomer are copolymerized in an aqueous medium, the possibility that the double bond portion of the macromonomer exists in the hydrophobic field that can be the field of polymerization is higher as the macromonomer has higher hydrophobic property. Accordingly, it is liable to be copolymerized with the hydrophobic monomer. The particles can be more stabilized in this way. Accordingly, in order to enhance polymerization stability within an aqueous medium, it is preferable that the hydrophilic monomer unit is originated from a monomer having alkyl group in the α-position. More specifically, it is preferable that 60 wt. % or more of them is originated from monomers having alkyl group in the α-position.

The macromonomer cannot be obtained at a high yield when the reaction temperature for producing the macromonomer composition is both too low and too high. The reason for low monomer concentration in the macromonomer composition is because the proportion of the polymers without terminal double bond generated increases.

The polymerization time is preferably in a range between 0.05 and 2 hours and more preferably in a range between 0.1 and 1 hour. The macromonomer yield can be low when the polymerization time is too short and the coloring of the macromonomer composition can be significant when the polymerization time is too long.

The macromonomer composition of the invention is preferably obtained when total amount of the monomer and polymer obtained from the same monomer (hereinafter also referred to as “the concentration of the monomers, etc.”) is in a concentration range of 50 and 100 wt. % with respect to the polymerization reaction solution in the production of the macromonomer composition. The concentration is more preferably in a range between 60 and 100 wt. % and further preferably in a range between 70 and 100 wt. %. The production efficiency of the macromonomer is high in this concentration and the reaction rate of the copolymerization reaction between the vinyl monomer is high. The major component other than the monomer and the polymers generated in the polymerization of the monomers is solvent. In other words, the preferable amount to be used for the solvent is 0 to 50 wt. %.

When using solvent, the solvent can be appropriately selected by taking into consideration, the solubilities of the raw material and the product and the reactivity with the raw material and the product. The examples are ketones, esters, ethers, alcohols, Cellosolves, carbitols, aliphatic hydrocarbons, alicyclic hydrocarbons, aromatic hydrocarbons and water, without limitation to these. More specifically, the examples are acetone, methylethyl ketone, cyclohexanone, ethyl acetate, butyl acetate, ethoxyethyl propionate, tetrahydrofuran, diethylene glycol monoethylether, diethylene glycol dimethylether, isopropyl alcohol, butylcellosolve, ethylcarbitol acetate, cyclohexan, toluene, xylene and water.

The macromonomer composition of the invention can be produced by polymerization techniques known in the art within the conditions described above. The examples of the polymerization techniques are: continuous polymerization; batch polymerization; and polymerization technique using tube reactor. The continuous polymerization is a preferred method; in particular, continuous polymerization using continuous stirring tank reactor. This is because the macromonomer can be efficiently obtained and because the copolymerization between the macromonomer and the vinyl monomer is developed smoothly so that the reaction rate of the macromonomer and the vinyl monomer can be high. The production of the macromonomer composition by continuous polymerization can be performed, for example as taught in PCT publications WO99/07755 and WO01/04163.

It is possible to use any known radical polymerization initiator in the production of the macromonomer composition. Optionally, any known chain transfer agent can also be used.

It is preferable that the macromonomer content in the macromonomer composition is 60 wt. % or more, and the content of the polymers devoid of terminal double bonds is 40 wt. % or less. This is because the yield of the copolymer is high in the reaction between the macromonomer composition and the vinyl monomer. It is more preferable when the macromonomer composition contains the macromonomer at 70 wt. % or higher.

The proportion of macromonomer content in the macromonomer composition can be calculated from the molecular weight obtained from gel permeation chromatography (hereinafter referred to as “GPC”) and the double bond concentration obtained from nuclear magnetic resonance spectroscopy (hereinafter referred to as “NMR”).

The reaction between the macromonomer composition and the vinyl monomer within the aqueous medium is next described.

In the production method of water-based resin dispersion of the present invention, macromonomer composition and vinyl monomer are reacted. In other words, the macromonomer contained in the macromonomer composition and the vinyl monomer are copolymerized.

In this case, there is no specific limitation to the usable vinyl monomer. It can be either of the above described vinyl monomer with alkyl group in the α-position, non-aromatic vinyl monomer having hydrogen atom in the α-position, styrene, or the other vinyl monomer. Preferably, monomers having functional group which enhances cohesion force by hydrogen bond, such as nitrile group, hydroxyl group and amide group, etc., can be used in addition. In particular, (meth)acrylonitrile, hydroxyethyl (meth)acrylate, diacetone (meth)acrylamide, etc., can be used as a monomer which has functional group which enhances cohesion force due to hydrogen bond. The amount of the vinyl monomer having these functional groups used is preferably 40 wt. % or less in order not to decrease the water resistance of the water-based resin dispersion, when cross-linking agent described below is not used.

It is further possible to provide functional groups for cross-linking in the water-based resin dispersion and cross-link these functional groups by cross-linking agent. The examples of the functional groups for cross-linking are carboxyl group, hydroxyl group, and carbonyl group, etc. The examples of the cross-linking agent are: metal salts; oxazolin resin; epoxy resin; melamine resin; (block)isocyanate compound; and polyhydrazide compound, etc. Among these cross-linking agents, combination of carbonyl group and polyhydrazide compound is preferable because of well-balanced one-component stability and low temperature cross-linking ability.

There is no specific limitation to the method for reacting the macromonomer composition and vinyl monomer, namely the method for copolymerizing the macromonomer contained in the macromonomer composition and the vinyl monomer. While any known polymerization technique such as emulsion polymerization, suspension polymerization, dispersion polymerization, etc., can be adopted, emulsion polymerization is preferable.

The method for supplying macromonomer to the reactor is not specifically limited. For example, a method in which the entire amount of the macromonomer is supplied to the reactor before initiating the reaction, a method in which a mixture of the macromonomer, vinyl monomer and water is continuously or intermittently supplied to the reactor, and a method in which a mixture of the macromonomer, vinyl monomer and water is continuously or intermittently supplied to emulsion which has been produced or which is in the course of production by using common emulsifier, can be used.

The polymerization temperature is preferably in a range between 20 and 95° C., and more preferably in a range between 40 and 90° C. The polymerization time is preferably between 1 and 10 hours.

Any known radical polymerization initiator can be used in the copolymerization. Both of water-soluble polymerization initiator and oil-soluble polymerization initiator can be used. Examples are: organic peroxides such as benzoyl peroxide, t-butyl peroxide, and dicmyl peroxide; azo-compounds such as azobis-isobutylonitrile, azobis(2-methylbutylonitrile), azobis-cyanovalerate; inorganic peroxides such as sodium persulfate, potassium persulfate, and ammonium persulfate; and Red-ox polymerization initiators which comprise such peroxide and reducing agent such as sulfites are combined. The amount of polymerization initiator used is preferably in a range between 0.01 and 5 wt. %, more preferably in a range between 0.1 and 3 wt. % with respect to the total weight of the macromonomer and vinyl monomer. Any known chain transfer agent can also be used when necessary.

The copolymer which is obtained through copolymerization of a macromonomer composition, which has hydrophilic group and hydrophobic group, and vinyl monomer within aqueous medium will be either of graft copolymer or block copolymer, or a mixture of both. Needless to say, unreacted macromonomer and a polymer in which the vinyl monomers are polymerized can also exist. The structure of the copolymer and the proportion at which the copolymer is obtained can vary depending on the composition of the macromonomer, kinds of vinyl monomer and polymerization conditions.

The macromonomer used for the present invention includes the vinyl monomer having alkyl group in the α-position as an indispensable component. Because a vinyl monomer having alkyl group in the α-position exists in the macromonomer, active radical portion which is generated by radical addition to the terminal double bond is able to perform β-cleavage before the addition of a vinyl monomer. Accordingly, a copolymer which has extremely narrow molecular weight distribution can be obtained, compared to the case where a macromonomer devoid of vinyl monomer component having alkyl group in the α-position is used. Since copolymers which includes macromonomer unit in graft or block form is obtained with extremely narrow molecular weight distribution, water-based resin dispersion of the invention is assumed to have excellent chemical stability and leveling performance.

The water-based resin dispersion is produced through methods described above. The water-based resin dispersion thus obtained can provide excellent performance as water-based sealer composition, water-based ink composition, water-based binder composition, coating agent composition and water-based coating composition. Specifically, when the proportion of the macromonomer composition to be reacted with vinyl monomer in aqueous medium is in a range between 20 and 300 wt. % with respect to the vinyl monomer, the water-based resin dispersion obtained is extremely stable to mixing and contact of inorganic salts including polyvalent metal ion (Ca²⁺, etc.). Therefore, excellent permeability can be provided in the applications to inorganic base materials such as siding board, gypsum board, and cement mortar board, etc. Because the inorganic base material is firmly reinforced due to good permeability, excellent adhesion can be obtained. Further, it is superior in processability because it has excellent leveling property as well as having good stability against film formation aiding agents such as alcohol. Therefore, the water-based resin dispersion as described above is preferable for sealers (sealant, base coating agent) for inorganic base materials. Further, the water-based resin dispersion obtained is also preferable for water-based ink because it is excellent in mixing stability with organic pigments, inorganic pigments and fillers, and in dispersibility.

On the other hand, when the proportion of the macromonomer composition to be reacted with the vinyl monomer within aqueous medium is in a range between 1 and 20 wt. % with respect to the vinyl monomer, the water-based resin dispersion obtained is superior in leveling property and chemical properties (stability against salt mixing and solvent mixing). Further, it is also possible to obtain a coating superior in water-resisting property and adhesiveness to the base material. Accordingly, the resin dispersion can also be used preferably for water-based coating composition in particular water-proof coating and polish, etc., for metal and plastic, etc., and for binder for various fibers or non-woven fabric.

A water-based dispersion obtained by emulsion polymerization of macromonomer which includes acrylic acid as an essential component and is obtained through thermal polymerization is disclosed in Japanese Laid-Open Patent Publication 2000-80288 (Rohm and Haas Company). The macromonomer disclosed in this publication is limited to a unit which has a terminal originated from acrylic acid. Further, since the macromonomer is used in a state in which it is not neutralized, emulsifier is used additionally in polymerization in aqueous medium. Moreover, because the macromonomer disclosed in an embodiment of the publication does not include hydrophobic monomer unit, the ability to form hydrophobic field is low to result in inferior ability to function as polymer emulsifier.

A method for producing graft copolymer by copolymerizing in aqueous medium, a neutralized macromonomer which includes carboxyl group is disclosed in Japanese National Phase Laid-Open Patent Publication 10-500721 (Du-Pont Company). The macromonomer used in this method is produced by reacting methacrylate monomer under the presence of cobalt chelate chain transfer agent. Accordingly, the monomer which forms the macromonomer is substantially limited to methacrylate to set limit to the function of water-based resin dispersion which comprises a graft copolymer using this macromonomer. It is also presumed that coloring and tarnishing can occur because of cobalt. In addition, macromonomer units constituted only from methacrylate is not preferable because it brings about degraded heat resistance.

PCT International Publication WO01/04163 (To a Gosei) discloses a method for producing water-based resin dispersion which uses neutralized macromonomer having carboxyl group that is produced through high temperature continuous polymerization technique. All the embodiments use macromonomers that are formed only from acrylic acid and acrylate ester. Accordingly, the water-based resin dispersion can have inferior permeability, chemical stability (specifically stability against salt-mixing) and leveling property depending on the conditions of the use.

According to the above embodiments, the macromonomer composition functions as polymer emulsifier because it has hydrophilic monomer unit and hydrophobic monomer unit. Further, due to copolymerization between the macromonomer and the vinyl monomer, the macromonomer can exist in a state where it is fixed onto the polymer particle surface by covalent bond. Accordingly, a water-based resin dispersion having better stability can be obtained. Further, the macromonomer is capable of forming a copolymer between the vinyl monomer with narrow molecular weight distribution. As a result, water-based resin dispersion having excellent permeability, leveling performance and chemical stability can be obtained.

In this case, the obtained water-based resin dispersion has excellent permeability, leveling performance and chemical stability when the content of the macromonomer composition with respect to the vinyl monomer is in a range between 20 and 300 wt. %. According to these properties, the obtained water-based resin dispersion can preferably be used, for example as water-based sealer.

On the other hand, when the content of the macromonomer composition with respect to the vinyl monomer is in a range between 1 and 20 wt. %, the obtained water-based resin dispersion specifically has excellent leveling performance, chemical stability and water resistance. In this case, the water-based resin dispersion can preferably be used for example as water-based coating compositions.

### EXAMPLES

The embodiments are described in more detail based on the examples. In the description below, “parts” denotes part by weight, and “%” denotes weight

### Production Example 1

### Production of Macromonomer Composition A1 and Its Neutralized Form A1N

Ethyl 3-ethoxypropionate was filled in a 500 ml pressurized stirring tank reactor-having a hot oil heater. The temperature within the reactor was set at 250° C. The pressure within the reactor was set, either at or to exceed a vapor pressure of ethyl 3-ethoxypropionate by means of pressure adjuster. A monomer mixture was prepared by weighing methyl methacrylate (hereinafter referred to as “MMA”) 55 parts, cyclohexyl acrylate (hereinafter referred to as “CHA”) 15 parts, acrylic acid (hereinafter referred to as “AA”) 35 parts and di-t-buthyl peroxide (hereinafter referred to as “DTBP”) 0.1 parts. The prepared mixture was stored in a raw material storage tank. The monomer mixture was continuously supplied from the raw material storage tank to the reactor by retaining the reactor at a constant pressure.

The rate of feed then was set so that the retention period of the monomer mixture within the reactor was 12 minutes. The reaction solution of an amount equal to the feed of the monomer mixture was continuously retracted from the outlet of the reactor. The reactor temperature was kept in a range between 230+2° C. while continuously supplying the monomer mixture. The reaction solution which was retracted from the reactor outlet was introduced into a thin film evaporator. A macromonomer composition was obtained by removing unreacted monomer from the reaction solution. Extraction of a macromonomer composition A1 from the outlet of the thin film evaporator was started 90 minutes after starting supply of the monomer mixture and the extraction was conducted for 60 minutes. The polymer was recovered at 85 wt. % from among the supplied monomers. The monomer conversion rate was 85%.

The average molecular weight of the macromonomer composition A1 was measured by gel permeation chromatography (hereinafter referred to as “GPC”) using tetrahydrofuran solvent. The number average molecular weight (hereinafter referred to as “Mn”) of the macromonomer composition A1 was 2370 by conversion from polystyrene. The weight average molecular weight (hereinafter referred to as “Mw”) was 5540. The concentration of ethylene-like unsaturated bond in any terminal of the macromonomer composition A1 was measured by ¹H-NMR. The rate of terminal ethylene-like unsaturated bond (hereinafter referred to as “F value”) of the macromonomer composition A1, as calculated from the number average molecular weight and the concentration of terminal ethylene-like unsaturated bond, was 96 wt. %.

Neutralization of carboxyl group was performed by adding aqueous ammonia that contains ammonia equivalent to acid value measured by neutralization titration of the macromonomer composition A1, to obtain macromonomer composition A1N (a solution containing solid content at 30% concentration).

### Production Examples 2-13

### Production of Macromonomer Compositions A2-A13 and Their Neutralized Form A2N-A13N

The macromonomer compositions were produced through the process steps similar to Production Example 1 except that the reaction temperatures were changed as shown in Tables 1 and 2. The average molecular weight and macromonomer content were measured. The respective neutralized form was manufactured through processes similar to Production Example 1. The results are shown in Table 1 and 2. In Table 1, “St” represents styrene; “MAA”, methacrylic acid; “BA”, butyl acrylate; and “EA”, ethyl acrylate.

TABLE 1

| | | A2 | A3 | A4 | A5 | A6 | A7 | A8 |
|---|---|---|---|---|---|---|---|---|
| Polymerization Temp. (° C.) | | 270 | 250 | 230 | 250 | 230 | 250 | 250 |
| Monomer | MMA | 55 | 50 | 50 | 32 | 50 | — | 55 |
| Component | MAA | — | — | — | 18 | — | 42 | — |
| | CHA | 10 | 25 | 35 | 50 | — | — | 5 |
| | BA | — | — | — | — | — | — | — |
| | EA | — | — | — | — | — | 58 | — |
| | AA | 35 | 25 | 15 | — | 50 | — | 35 |
| | St | — | — | — | — | — | — | 5 |
| Mw | | 2250 | 2890 | 4200 | 3050 | 6660 | 3160 | 3430 |
| Mn | | 1250 | 1320 | 1860 | 1440 | 2410 | 1642 | 1710 |
| F value (%) | | 95 | 83 | 86 | 90 | 100 | 92 | 91 |
| Neutralized | Name | A2N | A3N | A4N | A5N | A6N | A7N | A8N |
| Form | Solid | 30 | 30 | 30 | 30 | 30 | 30 | 30 |
| | Content | | | | | | | |
| | (%) | | | | | | | |

TABLE 2

| | | A9 | A10 | A11 | A12 | A13 |
|---|---|---|---|---|---|---|
| Polymerization Temp. (° C.) | | 250 | 250 | 250 | 270 | 285 |
| Monomer | MMA | 8 | — | — | — | — |
| Component | MAA | — | — | — | — | — |
| | CHA | 57 | 65 | 75 | — | — |
| | BA | — | — | — | 65 | — |
| | EA | — | — | — | — | 80 |
| | AA | 35 | 35 | 25 | 35 | 20 |
| Mw | | 3950 | 4360 | 4320 | 4980 | 4958 |
| Mn | | 1690 | 1770 | 1790 | 1800 | 1883 |
| F value (%) | | 82 | 93 | 83 | 97 | 83 |
| Neutralized | Name | A9N | A10N | A11N | A12N | A13N |
| Form | Solid | 30 | 30 | 30 | 30 | 30 |
| | Content. | | | | | |
| | (%) | | | | | |

### Production Example 14

### Production of Non-Reactive Resin Composition A14 and Its Neutralized Form A14N

After charging water 200 parts into a reaction tank which has stirrer, reflux condenser, thermometer and nitrogen introducing tube, the temperature within the tank was raised to 80° C. while stirring under nitrogen airflow. After confirming that the temperature was stable at 80° C., ammonium persulfate (hereinafter referred to as “APS”) 0.8 parts was added. After 5 minutes, a mixture of EA 52 parts, MAA 40 parts and octyl thioglycolate 8 parts was titrated into the flask by means of metering pump in a period of 2 hours. The temperature within the flask was controlled at 80±1° C. during titration. After finishing titration, an aqueous solution was added into the flask at the point when 30 minutes passed after keeping the temperature at 80° C. In the aqueous solution, sodium hydrosulfite 0.1 parts was dissolved into water 2 parts.

After retaining the temperature at 80° C. for 2 hours and then cooling, a non-reactive resin composition A13 in emulsion state was obtained. The composition A13 was dissolved in water by adding 25% aqueous ammonia 25 parts into the mixture and neutralizing the composition. Then by adding water to adjust the solid content at 30%, macromonomer A13N was produced. When acid was added to the composition A13N to precipitate resin, was washed with water, and then dried, any peak which was originated from terminal ethylene-like unsaturated bond, and which was observed in compositions A1-A12, was not observed through ¹H-NMR measurement.

### Production Example 15

### Production of Neutralized Polyacrylic Acid A15N

Neutralized Polyacrylic Acid A15N was produced by adjusting at pH8 Aron ALOSL manufactured by To a Gosei (40% aqueous solution of polyacrylic acid having Mw 6,000) by using 25% aqueous ammonia and then adding water so that solid content was 30%.

### Production Example 16

### Production of Water-Based Resin Dispersion S1

After charging water 320 parts and neutralized product A1N 333 parts (aqueous solution with 30% solid content) into a reaction tank having stirrer, reflux condenser, thermometer and nitrogen introducing tube, the temperature within the tank was raised to 81° C. while stirring under nitrogen airflow. After confirming that the temperature was stable at 81° C., ammonium persulfate (hereinafter referred to as “APS”) 0.3 parts was added. After 5 minutes, a monomer mixture shown in Table 3 and a solution in which APS 0.2 parts was dissolved in water 30 parts were respectively titrated into the flask by means of metering pump in a period of 2 hours. The temperature within the flask was controlled at 81±1° C. during titration. After finishing titration, the temperature was raised to 90° C. and an aqueous solution in which APS 0.1 parts was dissolved in water 4 parts was charged. After retaining the temperature at 90° C. for 2 hours, an emulsion was obtained by cooling.

Diethyleneglycol monobutyl ether 10 parts and dipropyleneglycol monobutyl ether 10 parts were added to the emulsion thus obtained, with respect to the 100 parts solid content. The product was then diluted by water to have solid content 15% to produce water-based resin dispersion composition S1.

### Production Examples 17-31

Water-based resin dispersion compositions S2-S16 were obtained by performing similar operations as the Production Example 16 except that the kinds of the neutralized products, the amount of charge and the component of the monomer mixtures were changed as shown in Tables 3 and 4.

### Examples 1-10

### Evaluation of Chemical Stability

Evaluation of chemical stability was performed with respect to water-based resin dispersion compositions S1-S10. Stability against salt mixing and stability against alcohol mixing were evaluated. The results are shown in Table 3. The conditions of the evaluation was as shown below.

(Stability Against Salt Mixing)

Condition A: Existence of cohesion was observed by adding 11.0 g of 10% calcium chloride aqueous solution to water-based resin dispersion composition 10.0 g. In Table 3: the symbol “∘” shows that cohesion did not occur; “Δ” shows that few cohesion occurred; and “X” shows that the entire cohesion occurred.

Condition B: Existence of cohesion was observed by adding 10.0 g of 10% calcium chloride aqueous solution to water-based resin dispersion composition 10.0 g. In Table 3: the symbol “∘” shows that cohesion did not occur; “Δ” shows that few cohesion occurred; and “X” shows that the entire cohesion occurred.

Condition C: Existence of cohesion was observed after heating at 40° C. for 24 hours, the sample which was shown by the symbol “◯” in Condition B. In Table 3: the symbol “◯” shows that cohesion did not occur; “Δ” shows that few cohesion occurred; and “X” shows that the entire cohesion occurred.

(Stability Against Alcohol Mixing)

Existence of cohesion was observed by adding isopropyl alcohol 10.0 g to water-based resin dispersion composition 10.0 g. In Table 3: the symbol “∘” shows that cohesion did not occur; “Δ” shows that few cohesion occurred; and “X” shows that the entire cohesion occurred.

### Comparative Examples 1-6

### Evaluation of Chemical Stability

Evaluation of chemical stability was performed with respect to water-based resin dispersion compositions S11-S16 in a manner similar to the Examples. The results are shown in Table 4.

TABLE 3

| | Production Example No. | | | | | | | | | |
|---|---|---|---|---|---|---|---|---|---|---|
| | 16 | 17 | 18 | 19 | 20 | 21 | 22 | 23 | 24 | 25 |
| Dispersion Composition | S1 | S2 | S3 | S4 | S5 | S6 | S7 | S8 | S9 | S10 |

Neutralized Product

| | | | | | | | | | | | |
|---|---|---|---|---|---|---|---|---|---|---|---|
| kind | | A1N | A1N | A1N | A1N | A1N | A1N | A3N | A6N | A7N | A8N |
| Amount [parts] | | 333 | 167 | 667 | 333 | 333 | 333 | 333 | 333 | 333 | 333 |
| Component | St | 70 | 70 | 50 | 70 | 65 | 60 | 70 | 70 | 70 | 70 |
| Of | HA | — | — | — | 25 | 25 | 25 | 25 | 25 | 25 | 25 |
| Monomer | BA | 30 | 30 | 50 | — | — | — | — | — | — | — |
| Mixture | HEMA | — | — | — | 5 | 5 | 5 | 5 | 5 | 5 | 5 |
| [parts] | AN | — | — | — | — | 5 | — | — | — | — | — |
| | DAAM | — | — | — | — | — | 10 | — | — | — | — |

Example No.

| | | 1 | 2 | 3 | 4 | 5 | 6 | 7 | 8 | 9 | 10 |
|---|---|---|---|---|---|---|---|---|---|---|---|
| Salt | Condition A | ◯ | ◯ | ◯ | ◯ | ◯ | ◯ | ◯ | ◯ | ◯ | ◯ |
| Mixing | Condition B | ◯ | ◯ | ◯ | ◯ | ◯ | ◯ | Δ | ◯ | ◯ | ◯ |
| Stability | Condition C | Δ | X | ◯ | ◯ | ◯ | ◯ | X | X | ◯ | X |
| Alcohol Mixing | | ◯ | ◯ | ◯ | ◯ | ◯ | ◯ | ◯ | ◯ | ◯ | ◯ |
| Stability | | | | | | | | | | | |

As shown in Table 3, salt mixing stability is excellent in Examples 1-10 (Conditions A and B) and the alcohol mixing stability is excellent.

TABLE 4

| | | Production Example No. | | | | | |
|---|---|---|---|---|---|---|---|
| | | 26 | 27 | 28 | 29 | 30 | 31 |
| Dispersion Composition | | S11 | S12 | S13 | S14 | S15 | S16 |
| Neutralized Product | | | | | | | |
| kind | | A9N | A10N | A12N | A13N | A14N | A15N |
| Amount [parts] | | 333 | 333 | 333 | 333 | 333 | 333 |
| Component | St | 70 | 70 | 70 | 70 | 70 | 70 |
| of | HA | 25 | 25 | 25 | 25 | 25 | 25 |
| Monomer | BA | — | — | — | — | — | — |
| Mixture | HEMA | 5 | 5 | 5 | 5 | 5 | 5 |
| [parts] | AN | — | — | — | — | — | — |
| | DAAM | — | — | — | — | — | — |

| | | Comparative Example No. | | | | | |
|---|---|---|---|---|---|---|---|
| | | 1 | 2 | 3 | 4 | 5 | 6 |
| Salt | Condition A | X | X | X | X | X | X |
| Mixing | Condition B | — | — | — | — | — | — |
| Stability | Condition C | — | — | — | — | — | — |
| Alcohol Mixing | | ◯ | ◯ | ◯ | ◯ | X | X |
| Stability | | | | | | | |

As shown in Table 4, the salt mixing stability is inferior (Condition A) in Comparative Examples 1-6 and the alcohol mixing stability is also inferior in Comparative Examples 5 and 6. In Table 4, St denotes styrene. HA, BA, HEMA, AN and DAAM respectively represents 2-ethylhexyl acrylate, butyl acrylate, 2-hydroxyethyl methacrylate, acrylonitrile and diacetone acrylamide.)

### Example 11

The water-based resin dispersion composition S1 is formed into a water-based sealer and the sealer was evaluated through an evaluation method described below.

Evaluation Method:

(1) Normal State Adhesiveness on Calcium Silicate Board

The composition S1 is applied, at the rate of 100 g/m², onto a calcium silicate board that is heated to 60° C. in advance. The sealer film is formed by drying at 100° C. for 10 minutes after application. A commercially available water-based finish coating was applied at 75 g/m² onto the sealer film and dried at room temperature for 3 days. The film on the calcium silicate was cut into grids with 4 mm distance by means of a cutter to form 25 grids. An adhesive tape (Cellotape manufactured by Nichiban) is then pressed against the films and then the adhesive tape was peeled off at once. The adhesiveness was evaluated in accordance with the equation shown below from the number of grids in which the film remained in almost complete manner on the calcium silicate board. As the value is nearer to 100, adhesive is superior.

Adhesiveness (%)=remaining grids/25×100

(2) Water-Proof Adhesiveness on Calcium Silicate Board

The composition S1 is applied, at the rate of 100 g/m², onto a calcium silicate board that is heated to 60° C. beforehand. A sealer film is formed by drying at 100° C. for 10 minutes after application. A commercially available water-based finish coating was applied at 75 g/m² onto the sealer film and dried at room temperature for 3 days. The sealer film along with the calcium silicate board was immersed into warm water at 60° C. for 24 hours and then dried by leaving the board at rest at room temperature for 3 days. The adhesiveness was then tested similarly to the paragraph (1). The results are shown in Table 5.

(3) Adhesiveness on Calcium Silicate Board With Scratched Surface

A calcium silicate board with its surface scratched by endless sander, was used. The composition S1 is applied, at the rate of 100 g/m², onto the scratched surface of the calcium silicate board that is heated to 60° C. beforehand. The adhesiveness was then tested similarly to paragraph (1). The results are shown in Table 5.

It has been shown that because the pores of the surface are clogged by the scratched powder and it is harder to permeate liquid, scratched surface has lower adhesiveness compared to unscratched surface.

(4) Normal State Adhesiveness on Slate Board

The composition S1 is applied, at the rate of 60 g/m², onto a slate board that is heated to 60° C. beforehand. A sealer film is formed by drying at 100° C. for 10 minutes after application. A commercially available water-based finish coating was applied at 75 g/m² onto the lealer film and dried at room temperature for 3 days. The adhesiveness was then tested similarly to paragraph (1). The results are shown in Table 5.

(5) Water-Resistant Adhesiveness on Slate Board

The composition S1 is applied, at the rate of 60 g/m², onto a slate board that is heated to 60° C. beforehand. A sealer film is formed by drying at 100° C. for 10 minutes after application. A commercially available water-based finish coating was applied at 75 g/m² onto the sealer film and dried at room temperature for 3 days. The sealer film along with the slate board was immersed into a warm water at 60° C. for 24 hours and dried by leaving the board at rest at room temperature for 3 days. The adhesiveness was then tested similarly to paragraph (1). The results are shown in Table 5.

(6) Adhesiveness on Slate Board With Scratched Surface

A slate board with its surface scratched by endless sander was used. The composition S1 is applied at the rate of 60 g/m² onto the scratched surface of the slate board that is heated to 60° C. beforehand. The adhesiveness was then tested similarly to paragraph (1). The results are shown in Table 5.

### Examples 12-19 and 21

The evaluation of the paragraphs (1) to (6) were performed with respect to compositions S2-S10 in a similar manner as composition S1. The results are shown in Table 5.

### Example 20

Dihydrazide adipate 3 parts was added with respect to 100 parts of the composition S6 and uniformly dissolved by sufficiently stirring to obtain cross-linked water-based resin dispersion composition S17. The evaluation of the paragraphs (1) to (6) were performed with respect to composition S17 in a similar manner as composition S1. The results are shown in Table 5.

### Comparative Examples 7-12

The evaluation of the paragraphs (1) to (6) were performed with respect to compositions S11-S16 in a manner similar to that of composition S1. The results are shown in Table 6.

TABLE 5

| | | Example No. | | | | | | | | | | |
|---|---|---|---|---|---|---|---|---|---|---|---|---|
| | | 11 | 12 | 13 | 14 | 15 | 16 | 17 | 18 | 19 | 20 | 21 |
| Dispersion Composition | | S1 | S2 | S3 | S4 | S5 | S6 | S7 | S8 | S9 | S17 | S10 |
| Adhesiveness | (1) | 92 | 88 | 96 | 92 | 96 | 96 | 88 | 96 | 92 | 96 | 88 |
| Evaluation | (2) | 80 | 86 | 72 | 80 | 88 | 88 | 84 | 72 | 84 | 92 | 86 |
| Result | (3) | 24 | 16 | 32 | 28 | 36 | 40 | 20 | 36 | 24 | 48 | 20 |
| | (4) | 92 | 96 | 96 | 96 | 100 | 96 | 92 | 96 | 96 | 100 | 96 |
| | (5) | 80 | 88 | 76 | 88 | 92 | 88 | 84 | 80 | 92 | 96 | 86 |
| | (6) | 64 | 36 | 76 | 72 | 76 | 76 | 44 | 72 | 68 | 92 | 48 |

TABLE 6

| | | Comparative Example No. | | | | | |
|---|---|---|---|---|---|---|---|
| | | 7 | 8 | 9 | 10 | 11 | 12 |
| Dispersion Composition | | S11 | S12 | S13 | S14 | S15 | S16 |
| Adhesiveness Evaluation | (1) | 80 | 84 | 68 | 80 | 72 | 88 |
| Result | (2) | 48 | 56 | 44 | 48 | 20 | 20 |
| | (3) | 0 | 0 | 0 | 0 | 0 | 0 |
| | (4) | 92 | 88 | 92 | 88 | 88 | 92 |
| | (5) | 52 | 60 | 40 | 52 | 24 | 20 |
| | (6) | 44 | 40 | 28 | 48 | 40 | 64 |

As shown in Tables 5 and 6, while adhesiveness was good in Examples 11 to 21 in general, specifically in those examples which used cross-linking agent, and the adhesiveness was inferior in Comparative Examples 7-12 compared to Examples 11-21.

### Production Example 32

### Production of Water-Based Resin Dispersion X1

After charging water 105 parts into a reaction tank having stirrer, reflux condenser, thermometer and nitrogen introducing tube, the temperature within the tank was raised to 81° C. while stirring under nitrogen airflow. After confirming that the temperature was stable at 81° C., ammonium persulfate (hereinafter referred to as “APS”) 0.5 parts was added into the flask. After 5 minutes, neutralized product of the composition shown in Table 2, a solution in which a monomer mixture was dissolved in water 60 parts, and a solution in which APS 0.5 parts was dissolved in water 18 parts, were respectively titrated into the flask by means of metering pump in a period of 2 hours. The temperature within the flask was controlled at 81+1° C. during titration. After finishing titration, the temperature was raised to 90° C. and an aqueous solution in which APS 0.1 parts was dissolved in water 4 parts was charged. After retaining the temperature at 90° C. for 3 hours, a water-based resin dispersion X1 was obtained by cooling.

### Production Example 33-35

Water-based resin dispersions X2-X4 were obtained through similar processes as Production Example 32 except that the kind of the neutralized products and the amount were altered as shown in Table 7.

### Examples 22 and 23

Evaluation of polymerization stability and chemical stability was performed on water-based resin dispersion X1. The polymerization stability was evaluated from generation of cohesion after finishing polymerization. The chemical stability was evaluated by salt-mixing stability and alcohol-mixing stability. The results are shown in Table 7. The conditions for the evaluation were as shown below.

(Evaluation of Polymerization Stability)

After finishing polymerization, the reaction solution was filtered through 200 mesh polynet and the existence of cohesion was observed. In table 7: the symbol “◯” shows that cohesion scarcely occurred; “Δ” shows that few cohesion occurred; and “X” shows that significant amount of cohesion occurred.

(Stability Against Salt Mixing)

Condition A: Existence of cohesion was observed by adding 0.1 g of 10% calcium chloride aqueous solution to water-based resin dispersion composition 10.0 g. The symbol “∘” shows that cohesion did not occur; “Δ” shows that a few cohesion occurred; and “X” shows that significant amount of cohesion occurred.

Condition B: Existence of cohesion was observed by adding 0.2 g of 10% calcium chloride aqueous solution to water-based resin dispersion composition 10.0 g. The symbol “∘” shows that cohesion did not occur; “Δ” shows that a few cohesion occurred; and “X” shows that significant amount of cohesion occurred.

Condition C: Existence of cohesion was observed by adding 11.0 g of 10% calcium chloride aqueous solution to water-based resin dispersion composition 10.0 g. The symbol “∘” shows that cohesion did not occur; “Δ” shows that a few cohesion occurred; and “X” shows that significant amount of cohesion occurred.

(Stability Against Alcohol Mixing)

Existence of cohesion was observed by adding methanol 2.0 g to water-based resin dispersion composition 10.0 g. The symbol “∘” shows that cohesion did not occur; “Δ” shows that a few cohesion occurred; and “X” shows that cohesion occurred in the entirety.

(Evaluation of Water-Based Resin Dispersion Compositions X1-X4 as Water-Resistant and Alcohol-Resistant Coating)

### Examples 24 and 25

Further, water-based resin dispersion compositions X1 and X2 were evaluated with respect to the function of water-resistant and alcohol-resistant coating in the methods as described below. The results are shown in Table 8.

(Preparation of Water-Based Resin Dispersion Composition Samples)

Water-based resin dispersion compositions SX1 and SX2 were obtained by adding 15 parts of diethyleneglycol monobutylether acetate to the water-based resin dispersions X1 and X2, with respect to 100 parts of the solid content.

(Evaluation of Water-Resistance and Alcohol-Resistance)

(Rubbing-Resistance Test)

Water-based resin dispersion composition SX1 was applied onto a glass board at the rate of 2 g/m². A coating film was formed by drying at 80° C. for 1 minute after application. The coating surface was rubbed for 10 times with absorbent cotton that is immersed with water or alcohol (methanol, ethanol, isopropyl alcohol). The appearance of the coating film was evaluated by visual inspection. The symbol “∘” shows that there was no change; “Δ” shows that there was a few whitening; and “X” shows that the coating peeled off.

(Spot-Resistant Test)

Water-based resin dispersion composition SX1 was applied onto a glass board at the rate of 2 g/m². A coating film was formed by drying at 80° C. for 1 minute after application. A drop of water or alcohol (methanol, ethanol, isopropyl alcohol) was dropped onto the film surface. The droplet on the film surface was gently wiped off, either immediately after the drop, after 60 minutes or after 120 minutes, and the appearance of the film was evaluated by visual inspection. The symbol “∘” shows that there was no change; “Δ” shows that there was a few whitening; and “X” shows that the coating peeled off.

TABLE 7

| | | Production Example No. | | | |
|---|---|---|---|---|---|
| | | 32 | 33 | 34 | 35 |
| Water-Based Dispersion Composition | | X1 | X2 | X3 | X4 |
| Neutralized Product | | | | | |
| kind | | A1N | A7N | A9N | A13N |
| Amount [parts] | | 13 | 13 | 13 | 13 |
| Monomer Mixture | St | 70 | 70 | 70 | 70 |
| [parts] | HA | 30 | 30 | 30 | 30 |

| | | Example No. | | | |
|---|---|---|---|---|---|
| | | 22 | 23 | — | — |
| | | Comparative Example No. | | | |
| | | — | — | 13 | 14 |
| Polymerization Stability | | Δ | ◯ | ◯ | X |
| Salt Mixing | Condition A | ◯ | ◯ | ◯ | X |
| Stability | Condition B | ◯ | ◯ | Δ | X |
| | Condition C | ◯ | ◯ | X | X |
| Alcohol Mixing | | ◯ | ◯ | ◯ | X |
| Stability | | | | | |

As shown in Table 7, all of polymerization stability, salt-mixing stability and alcohol-mixing stability were good in Examples 22 and 23. On the other hand, the salt-mixing stability was inferior in Comparative Example 13 and all of polymerization stability, salt-mixing stability and alcohol-mixing stability were inferior in Comparative Example 14.

TABLE 8

| | | Dispersion Composition | | | |
|---|---|---|---|---|---|
| | | SX1 | | SX2 | |
| Stability when Film Forming Aid is Added | | ◯ | | ◯ | |
| | | Example No. | | | |
| | | 24 | | 25 | |
| | | Comparative Example No. | | | |
| | | — | | — | |
| Rubbing | water | ◯ | | ◯ | |
| test | methanol | ◯ | | ◯ | |
| | ethanol | Δ | | Δ | |
| | isopropanol | Δ | | Δ | |
| Spot | Time [minutes] | 60 | 120 | 60 | 120 |
| test | water | ◯ | ◯ | ◯ | ◯ |
| | methanol | ◯ | ◯ | ◯ | ◯ |
| | ethanol | ◯ | ◯ | ◯ | ◯ |
| | isopropanol | ◯ | ◯ | ◯ | ◯ |

As shown in Table 8, the results of both rubbing-resistant test and spot-resistant test were excellent in Examples 24 and 25.

### Examples 26-30

Water 60 parts and lauryl sodium sulphate 0.5 parts were charged in a reaction tank having stirrer, reflux condenser, two titration funnels, thermometer and nitrogen introducing tube, and the temperature was raised to 85° C.

Lauryl sodium sulfate 0.5 parts and water 30 parts were added to a monomer mixture of the first stage composition shown in Table 9 to emulsify. The emulsified monomer liquid thus obtained and 5% ammonium persulfate aqueous solution 10 parts were continuously titrated into the reaction tank in 2 hours by means of respective separate titration funnel to cause emulsion polymerization. The temperature within the reaction tank was kept at 85° C. for 30 minutes after finishing titration.

Monomer mixture of the second stage composition shown in Table 9, neutralized macromonomer and water were mixed and emulsified. The emulsion monomer liquid of the second stage and 5% ammonium persulfate aqueous solution 2 parts were continuously titrated into the reaction tank in 30 minutes by means of respective separate titration funnel to cause emulsion polymerization. Polymerization was finished by cooling the system, 1 hour after finishing titration.

Zinc oxide was then mixed so that zinc ion equivalent was 20% of the carboxyl group within the polymers and water-based resin dispersion having 38% solid content concentration was obtained. The zinc oxide mixed here has been solubilized in advance by using ammonium bicarbonate and aqueous ammonia.

Further, various additives are added to the water-based resin dispersion at the percentage shown in Table 10 and stirred to obtain water-based polish composition.

### Comparative Examples 15-17

Water-based polish was obtained through the similar processes as Example 1 except that the monomer mixture and macromonomer solution were used as shown in Table 11.

The water-based polish-thus obtained was applied onto a base material and test pieces with the films were formed. Various physical properties were evaluated by using the test pieces as described below. The results of evaluation are shown in Table 12.

(Forming Test Pieces)

A homogeneous polyvinyl floor tile of solid black color was used for the base material. This tile is a standard tile for the testing standard of Japan Floor Polish Association (JFPA). The base material was cleaned by a method described in Japanese Standards Association (hereinafter referred to as “JIS”) K3920 by using “51 Line Red Buffer Pad” manufactured by Sumitomo 3M Ltd. Note that this cleaning condition was extremely mild cleaning condition compared with the polish applications for actual building floors.

The water-based polish was spread over the base material surface at the rate of approximately 20 g per square meters (the amount of application is altered as shown below only in the case of leveling property) and dried at room temperature for one hour. The applications were performed for a plurality of times if necessary. The test pieces were thus obtained. The physical properties measured are shown below.

(1) Leveling Property: The polish was spread over once, an X-shaped mark (hereinafter referred to as “X-mark”) was applied onto the surface of the test pieces by absorbent gauze before being dried, and then the film was dried. The surface condition was observed by visual inspection and evaluation was performed by five steps.

5: X-mark was invisible.

4: A portion of X-mark profile was slightly visible as a difference in gloss.

3: X-mark profile was distinctly visible as a difference in gloss.

2: A portion of X-mark was visible as ridge.

1: Entire profile of X-mark was in ridge form with rough flatness.

Note that evaluation was performed in 2 levels of the application amount shown below. The condition B, in which the amount of application was less, was hard to cause leveling and was liable to cause problems.

Condition 1: Each water-based polish at approximately 20 g per square meters

Condition 2: Each water-based polish at approximately 10 g per square meters

(2) Gloss: With respect to the test piece surfaces on which polish was applied 4 times, 60 degrees gloss was measured. The term “60 degrees gloss” denotes the level of gloss as measured by placing the light receiver at measuring angle 60 degrees with respect to the measuring plane, namely at an angle of 60 degrees from the normal line of the measuring plane. The measurement result shows an average of 3 measurement of 60 degrees gloss.

(3) Adhesiveness: Tape peeling test was performed on the test piece surfaces on which gloss was applied 4 times. Rate of remained film area (%) as averaged from 5 measurements is shown.

(4) Water-resistance: After leaving the test pieces with one coating at room temperature at relative humidity 80% or less for 24 hours, 0.2 ml distilled water was dropped onto the coating surface. The droplet was wiped off after leaving it for 1 hour. The level of whitening was observed by visual inspection on the coating surface after 30 minutes and evaluation was performed by 5 steps.

5: There was no whitening or damage.

4: A profile of whitening was slightly visible.

3: Whitening was partially visible. There was no blister.

2: Whitening was visible in its entirety. There was no blister.

1: Overall whitening along with blister was visible.

(5) Black Heel Mark Resistance (BHM Resistance): The test pieces with 3 coatings applied onto a solid white color homogeneous tile was left at room temperature under relative humidity 80% or less for 24 hours. The test pieces were set on a heel mark tester described in JIS K3920 and 6 standard rubber blocks having 50 cubic millimeter were put into the tester. The test pieces were rotated, in both clockwise and anticlockwise directions at rotational speed of 50 rpm, respectively for 2.5 minutes. The amount of black heel mark (BHM, black colored dirt similar to that obtained by rubbing) was observed by visual inspection. Relative evaluation was performed by 5 steps, in which those devoid of black rubbing dirt was 5 and those with much of dirt was 1.

(6) Scuff Resistance: The amount of scuff mark (trace similar to hard-edged scratch) applied onto the test piece surfaces were observed by visual inspection and relative 5-step evaluation was performed. The test pieces were the same as those used in evaluation of BHM resistance.

TABLE 9

| | | Example | Example | Example | Example | Example |
|---|---|---|---|---|---|---|
| | | 26 | 27 | 28 | 29 | 30 |
| First | Styrene | 28.0 | 31.0 | 31.0 | 36.0 | 36.0 |
| step | Methyl | 10.0 | 15.0 | 15.0 | 12.0 | 12.0 |
| | methacrylate | | | | | |
| | Butyl acrylate | 27.0 | 27.0 | 27.0 | 25.0 | 25.0 |
| | Methacrylic acid | 20.0 | 20.0 | 20.0 | 20.0 | 20.0 |
| Second | Styrene | 15.0 | 7.0 | 7.0 | 7.0 | 7.0 |
| step | Neutralized | 58.8 | 17.5 | 0.0 | 0.0 | 0.0 |
| | macromonomer A3N | | | | | |
| | Neutralized | 0.0 | 0.0 | 17.5 | 0.0 | 0.0 |
| | macromonomer A1N | | | | | |
| | Neutralized | 0.0 | 0.0 | 0.0 | 17.5 | 0.0 |
| | macromonomer A4N | | | | | |
| | Neutralized | 0.0 | 0.0 | 0.0 | 0.0 | 17.5 |
| | macromonomer A5N | | | | | |

TABLE 10

| | | | | Molecular |
|---|---|---|---|---|
| | | | Concentra- | Weight |
| | Product Name | Manufacturer | tion | Ratio |
| Diluted | Ion Exchange | — | — | 40.66 |
| Water | Water | | | |
| Humectant | FC-129 | 3M | 1% | 0.36 |
| Antifoaming | NOPCO NXZ | San Nopco | — | 0.02 |
| Agent | | | | |
| Film | Methylcarbitol | Daicel | — | 3.33 |
| Forming | | Chemical | | |
| Aid | | Industries | | |
| | | Ltd. | | |
| Film | Dowanol DPM | Dow | — | 3.33 |
| Forming | | Chemical | | |
| Aid | | | | |
| Leveling | TBXP | Daihachi | — | 1.14 |
| Agent | | Chemical | | |
| | | Industry | | |
| | | Co. Ltd. | | |
| Plasticizer | Dibutyl | Chisso | — | 1.14 |
| | Phthalate | Corporation | | |
| Polymer | Synthetic | — | 38% | 37.30 |
| | Resin of each | | | |
| | example | | | |
| Alkali | Durez 19788 | Sumitomo | 15% | 5.90 |
| soluble | | Bakeright | | |
| resin | | | | |
| Wax | Hytec E-4B | Toho Kagaku | 40% | 6.82 |

TABLE 11

| | | Example | Example | Example |
|---|---|---|---|---|
| | | 15 | 16 | 17 |
| First | Styrene | 28.0 | 28.0 | 31.0 |
| step | Methyl methacrylate | 10.0 | 10.0 | 15.0 |
| | Butyl acrylate | 27.0 | 27.0 | 27.0 |
| | Methacrylic acid | 20.0 | 20.0 | 20.0 |
| Second | Styrene | 15.0 | 15.0 | 7.0 |
| step | Neutralized | 58.8 | 0.0 | 0.0 |
| | macromonomer A10N | | | |
| | Neutralized | 0.0 | 58.8 | 0.0 |
| | macromonomer A9N | | | |
| | Neutralized | 0.0 | 0.0 | 17.5 |
| | macromonomer A11N | | | |

TABLE 12

| | | | | | | | Comparative | | |
|---|---|---|---|---|---|---|---|---|---|
| | | Examples | | | | | Examples | | |
| | | 26 | 27 | 28 | 29 | 30 | 15 | 16 | 17 |
| Leveling | Condition A | 5 | 5 | 5 | 5 | 5 | 4 | 4 | 5 |
| Property | Condition B | 4 | 5 | 5 | 5 | 5 | 1 | 2 | 3 |

| | | | | | | | | |
|---|---|---|---|---|---|---|---|---|
| Gloss | 82 | 85 | 82 | 86 | 83 | 82 | 80 | 80 |
| Adhesiveness | 100 | 90 | 85 | 90 | 90 | 100 | 100 | 90 |
| Water Resistance | 4 | 5 | 4 | 5 | 5 | 4 | 4 | 5 |
| BHM Resistance | 4 | 5 | 5 | 5 | 5 | 3 | 4 | 5 |
| Scuff Resistance | 4 | 5 | 5 | 5 | 4 | 3 | 4 | 5 |

As shown in Table 12, various properties are excellent in general in Examples 26-30 compared to Comparative Examples 15-17.

Note that it would be obvious to those skilled in the art that the present invention can be implemented in other various embodiments without departing from the spirit and the scope of the invention. For example, the present invention can be implemented as described below.

It is possible to use by appropriately mixing a water-based resin dispersion including macromonomer composition at a proportion between 1-20 wt. % with respect to the vinyl monomer and a water-based resin dispersion including macromonomer composition of 20-300 wt. %.

It is also possible to use in combination a water-based resin dispersion according to one embodiment and a resin dispersion which is obtained through copolymerization of a macromonomer composition and a vinyl monomer within an organic solvent.

According to the production method of the invention, the various properties of the macromonomer composition or a copolymer obtained from the macromonomer composition. Further, it is possible to obtain a macromonomer at an excellent efficiency in accordance with the invention. The reaction proceeds smoothly when the macromonomer and the vinyl monomer are reacted and the reaction rate of the macromonomer and the vinyl monomer can be enhanced in accordance with the production method of the invention.

1. A method for producing water-based resin dispersion by causing reaction between a macromonomer composition and a vinyl monomer in an aqueous medium, wherein the macromonomer composition includes a hydrophilic monomer unit and a hydrophobic monomer unit and is obtained through polymerization of a monomer mixture in a temperature range between 160° C. and 350° C., wherein the monomer mixture contains, with respect to the total amount of all monomers provided for the production of the macromonomer composition: a vinyl monomer having alkyl group in the α-position at 10 to 80 weight %; and a non-aromatic vinyl monomer having hydrogen atom in the α-position at 90 to 20 weight %.

2. A method for producing water-based resin dispersion by causing reaction between a macromonomer composition and a vinyl monomer in an aqueous medium, wherein the macromonomer composition includes a hydrophilic monomer unit and a hydrophobic monomer unit and is obtained through polymerization of a monomer mixture in a temperature range between 160° C. and 350° C., wherein the monomer mixture contains, with respect to the total amount of all monomers provided for the production of the macromonomer composition: a vinyl monomer having alkyl group in the α-position at 70 weight % or more; and styrene at 30 weight % or less.

3. A method for producing water-based resin dispersion by causing reaction between a macromonomer composition and a vinyl monomer in an aqueous medium, wherein the macromonomer composition includes a hydrophilic monomer unit and a hydrophobic monomer unit and is obtained through polymerization of a monomer mixture in a temperature range between 160° C. and 350° C., wherein the monomer mixture contains, with respect to the total amount of all monomers provided for the production of the macromonomer composition: a vinyl monomer having alkyl group in the α-position at 10 to 80 weight %; a non-aromatic vinyl monomer having hydrogen atom in the α-position at 90 weight % or less; and styrene at 30 weight % or less.

4. A method for producing water-based resin dispersion according to any one of claims 1 to 3, wherein 60 weight % or more of the hydrophilic monomer unit contained in the macromonomer composition is originated from the vinyl monomer having alkyl group in the α-position.

5. A method for producing water-based resin dispersion according to any one of claims 1 to 3, wherein a hydrophilic group which forms the hydrophilic monomer unit contained in the macromonomer composition is carboxyl group.

6. A method for producing water-based resin dispersion according to claim 5, wherein a portion or all of a plurality of the carboxyl groups contained in the macromonomer composition are neutralized by alkali.

7. A method for producing water-based resin dispersion according to any one of claims 1 to 3, wherein the macromonomer composition is obtained by polymerization when the entire amount of a monomer and a polymer generated through polymerization of the monomer is in a concentration range between 50 and 100 weight % with respect to the amount of polymerization reaction solution in production of the macromonomer composition.

8. A method for producing water-based resin dispersion according to any one of claims 1 to 3, wherein the vinyl monomer having alkyl group in the α-position is methacrylic acid or methacrylate ester.

9. A method for producing water-based resin dispersion according to any one of claims 1 to 3, wherein the proportion of the macromonomer composition which reacts with the vinyl monomer in the aqueous medium is in a range between 20 and 300 weight % with respect to the vinyl monomer.

10. A method for producing water-based resin dispersion according to any one of claims 1 to 3, wherein the proportion of the macromonomer composition which reacts with the vinyl monomer in the aqueous medium is in a range between 1 and 20 weight % with respect to the vinyl monomer.

11. A method for producing water-based resin dispersion according to any one of claims 1 to 3, wherein the macromonomer composition is obtained in a polymerization time of between 0.1 and 1 hour.

12. A water-based resin dispersion produced through the method for producing water-based resin dispersion according to any one of claims 1 to 3.

13. A water-based sealer composition produced through the method for producing water-based resin dispersion according to claim 9.

14. A water-based coating composition produced through the method for producing water-based resin dispersion according to claim 10.
